(19) United States
(12) Patent Application Publication
(10) Pub. No.: US 2014/0266980 A1
(43) Pub. Date: Sep. 18, 2014

(54) Providing an Altered Shopping Experience in Retail Environments

(71) Applicants: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(72) Inventors: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(21) Appl. No.: 14/289,382

(22) Filed: May 28, 2014

Related U.S. Application Data
(62) Division of application No. 13/710,251, filed on Dec. 10, 2012.
(60) Provisional application No. 61/569,119, filed on Dec. 9, 2011.

(51) Int. Cl. H04N 5/262; G06F 3/14

(52) U.S. Cl. CPC H04N 5/2628; G06F 3/1423
USPC 345/1.3

(57) ABSTRACT

An altered shopping experience can be provided in a retail store. Various devices can be used to provide a stimulus (e.g. a smell or sound) to encourage the customer to purchase a product, to entertain the customer, or to provide information to the customer. Devices can also be provided for creating a forced perspective to give the appearance that an aisle is shorter than it is. Devices can also be provided to automatically identify ingredients in a recipe and identify retail stores that offer the ingredients at the best price, or to accept reservations for particular products in the case of an emergency.

### CROSS-REFERENCE TO RELATED APPLICATIONS

This application is a divisional of U.S. patent application Ser. No. 13/710,251, filed Dec. 10, 2012, which claims priority to U.S. Provisional Patent Application No. 61/569,119 which was filed on Dec. 9, 2011 and titled “System and Method For Providing An Altered Shopping Experience In Retail Environments.”

### BACKGROUND

Manufactures and merchants both employ a wide variety of advertising techniques to attract and entice customers to purchase items that are stored and displayed on shelves. Because the shelf is often the last decision point in a buying decision, the ability to influence a customer's last decisive moments before the customer leaves the shelf often depends on the ability of the display to catch the customer's attention.

Currently, there are several ways in which manufactures and merchants try to catch a customer's attention at the point of purchase. For example, some manufactures and merchants place static advertisements in close proximity to a target product. These static advertisements often rely on artistry, color, advertised price, or shelf location to attract customers. Many customers tend to overlook these advertisements as commonplace objects. Thus, static advertisements frequently fail to catch a customer's attention. In an effort to be more effective, some static advertisements incorporate blinking lights with their otherwise static displays.

Manufacturers and merchants also use dynamic displays (e.g. video or audio displays). Oftentimes, these dynamic displays make navigating an aisle more difficult. Similarly, such displays may also become damaged, tattered, or unattractive.

Displays are often overused, such as by being placed to close together, which minimizes the effectiveness of each display.

### BRIEF SUMMARY

The present invention extends to methods, systems, and computer program products for providing an altered shopping experience in a retail store. For example, various devices can be used to provide a stimulus (e.g. a smell or sound) to encourage the customer to purchase a product, to entertain the customer, or to provide information to the customer. Devices can also be provided for creating a forced perspective to give the appearance that an aisle is shorter than it is. Devices can also be provided to automatically identify ingredients in a recipe and identify retail stores that offer the ingredients at the best price, or to accept reservations for particular products in the case of an emergency.

In one embodiment, the present invention provides a method for outputting a stimulus to enhance a customer's experience while shopping in a retail store. The presence of a customer is detected near a device for outputting a stimulus. An identification of the customer is received. Information about the customer is accessed to determine whether a stimulus is to be provided to the customer. Based on the accessed information, a stimulus is output to enhance the shopping experience of the customer.

In another embodiment, the present invention provides a system for generating a forced perspective that creates the perception that an aisle in a retail store is shorter than the aisle is. The system comprises a plurality of displays positioned in or above an aisle. The displays are arranged along the length of the aisle. The same image is displayed on each display with the size of the image being varied such that the size of the image on a display positioned at the end of the aisle is greater than the size of the image on a display positioned at the center of the aisle.

In another embodiment, the present invention provides a method for automatically determining ingredients in a recipe and identifying locations where the ingredients can be obtained. User input that identifies a recipe is received. It is determined which ingredients are in the recipe. Information is accessed over a network from a plurality of retail stores. The information identifies products for sale at the retail store. It is determined whether the retail stores offer any of the ingredients of the recipe. It is identified which retail store offers each ingredient for the best price. Each ingredient and the retail store that offers the ingredient for the best price is then displayed to the user.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary environment in which embodiments of the present invention can be implemented;

FIGS. 2A-2E illustrate various devices that can be used to implement embodiments of the present invention; and

FIG. 3 illustrates a flowchart of an exemplary method for outputting a stimulus to enhance a customer's experience while shopping in a retail store.

### DETAILED DESCRIPTION

The present invention extends to methods, systems, and computer program products for providing an altered shopping experience in a retail store. For example, various devices can be used to provide a stimulus (e.g. a smell or sound) to encourage the customer to purchase a product, to entertain the customer, or to provide information to the customer. Devices can also be provided for creating a forced perspective to give the appearance that an aisle is shorter than it is. Devices can also be provided to automatically identify ingredients in a recipe and identify retail stores that offer the ingredients at the best price, or to accept reservations for particular products in the case of an emergency.

In one embodiment, the present invention provides a method for outputting a stimulus to enhance a customer's experience while shopping in a retail store. The presence of a customer is detected near a device for outputting a stimulus. An identification of the customer is received. Information about the customer is accessed to determine whether a stimulus is to be provided to the customer. Based on the accessed information, a stimulus is output to enhance the shopping experience of the customer.

In another embodiment, the present invention provides a system for generating a forced perspective that creates the perception that an aisle in a retail store is shorter than the aisle is. The system comprises a plurality of displays positioned in or above an aisle. The displays are arranged along the length of the aisle. The same image is displayed on each display with the size of the image being varied such that the size of the image on a display positioned at the end of the aisle is greater than the size of the image on a display positioned at the center of the aisle.

In another embodiment, the present invention provides a method for automatically determining ingredients in a recipe and identifying locations where the ingredients can be obtained. User input that identifies a recipe is received. It is determined which ingredients are in the recipe. Information is accessed over a network from a plurality of retail stores. The information identifies products for sale at the retail store. It is determined whether the retail stores offer any of the ingredients of the recipe. It is identified which retail store offers each ingredient for the best price. Each ingredient and the retail store that offers the ingredient for the best price is then displayed to the user.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

FIG. 1 illustrates an exemplary computer environment 100 in which the present invention can be implemented. Computer environment 100 includes server system 101, and devices 102a-102n. Devices 102a-102n can be controlled by server system 101 to perform a desired function.

Server system 101 can comprise any number and type of computing devices or components. For example, server system 101 can comprise a single server device or a plurality of interconnected server components forming a cloud.

Devices 102a-102n can be any of various types of devices that can output audio content, visual content, scents, etc. as will be further described below.

Network 103 can represent various types of networks such as the internet, a local area network within a retail location, or any other type of network that allows content or controls signals to be transferred from server system 101 to devices 102a-102n.

FIG. 2A illustrates a device 102a that is configured to output a scent to stimulate a customer to purchase a particular product. For example, device 102a can output a fresh linen smell 201 to improve sales of linens 210. Similarly, device 102a can output a strawberry smell in the produce section to increase sales of strawberries, or output a smell of cake near the cake decorating aisle. In other embodiment, device 102a can be configured to output sounds to obtain a similar effect.

Device 102a can be configured to detect the presence of a customer near the device and output an appropriate smell. For example, in some embodiments, a computing device carried by the customer can be detected (e.g. by device 102a, another device, or by server system 101), and it can be determined whether a smell should be output or what type of smell should be output (e.g. if the customer prefers peaches over strawberries, a peach smell can be output).

FIG. 2B illustrates devices 102b that are configured to create a forced perspective within an aisle to cause the aisle to appear shorter. For example, devices 102b can be positioned near or above store aisles to create the perception of shallowness. This perception can be created by displaying the same image on each display with each image being smaller the closer the corresponding display is to the center of the aisle. As shown in FIG. 2B, an image of a circle is displayed on each device 102b with the circle being largest at the end of the aisles and smallest at the center of the aisle. Such displays can reduce a shopper's aversion to long aisles.

FIG. 2C illustrates devices 102c that are configured to output sound to provide a surround sound experience to a customer. For example, the presence of a customer can be detected as described above, and an appropriate sound can be output to encourage the purchase of a product, provide entertainment to the customer, or otherwise enhance the shopping experience. The sound can be an advertisement of a product, information about a product or the retail store, entertainment such as music, etc.

FIG. 2D illustrates a device 102d that can be configured to display content that is customized for a customer that is detected as being proximate the device. For example, device 102d can comprise a television or other type of video display device that can display advertisements that are customized for the nearby customer. The presence of a customer can be detected in the manner described above. Once the customer is detected, information about the customer (e.g. preferences, purchase history, demographics, etc.) can be used to customize content for display on device 102d.

FIG. 2E illustrates a device 102e that is configured to automatically identify products in a recipe and locations where the products can be obtained at the best price. For example, device 102e can comprise a smart phone, tablet, or other type of personal computing device. When a user identifies a recipe, device 102e can search for retail locations that provide each product required by the recipe and determine one or more locations that provide a product for the best price. Device 102e can also be configured to generate a map for guiding the user to the locations.

In some embodiments, a device, such as device 102e, can be configured to automatically generate a recipe based on user preferences, such as preferred ingredients, number of servings, dietary restrictions, etc. Recipes can be generated by locating a recipe from a recipe library, modifying an existing recipe, or creating an original recipe. An original recipe can be created by identifying ingredients that complement one another. The device can further identify where to purchase each ingredient in the recipe as described above with respect to FIG. 2E.

In some embodiments, a device, such as device 102e, can be configured to accept reservations for certain products in the case of a natural disaster or other emergency. In this way, a customer can reserve access to products without having to compete for the products at the retail location.

In some embodiments, a device can be configured to monitor a customer's response to advertisements displayed on the device. For example, if a user clicks on an advertisement, the click can be tracked. Further, certain advertisements can be denoted with a color or other label to indicate that they are sponsored advertisements.

FIG. 3 illustrates a flowchart of an exemplary method 300 for outputting a stimulus to enhance a customer's experience while shopping in a retail store. Method 300 can be implemented by one or more computer systems connected to a device, or by the device.

Method 300 includes an act 301 of detecting the presence of a customer near a device for outputting a stimulus. For example, the presence of a customer can be detected by receiving a signal from a portable computing device carried by the customer, or by directly receiving customer input.

Method 300 includes an act 302 of receiving an identification of the customer. For example, a signal or input received from the customer or the customer's device can identify the customer.

Method 300 includes an act 303 of accessing information about the customer to determine whether a stimulus is to be provided to the customer. For example, a customer profile or loyalty account can be accessed to determine whether a stimulus would enhance the customer's shopping experience.

Method 300 includes an act 304 of, based on the accessed information, outputting a stimulus to enhance the shopping experience of the customer. For example, a smell or sound can be output to enhance the customer's shopping experience.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A system for generating a forced perspective that creates the perception that an aisle in a retail store is shorter than the aisle is, the system comprising:
a plurality of displays positioned in or above an aisle, the plurality of displays being arranged along the length of the aisle, wherein the same image is displayed on each display with the size of the image being varied such that the size of the image on a display positioned at the end of the aisle is greater than the size of the image on a display positioned at the center of the aisle.

2. The system of claim 1, wherein the displays are attached to one or more shelves in the aisle.

3. The system of claim 1, wherein the plurality of displays comprises at least three displays.

4. The system of claim 1, wherein the displays extend out from one or more shelves of the aisle.

5. The system of claim 1, wherein the displays are positioned perpendicular to one or more shelves of the aisle.

6. The system of claim 1, wherein the displays are positioned above the aisle.

7. The system of claim 1, wherein the displays are the same size.

8. A method for generating a forced perspective, the method comprising:
displaying an image on a first display positioned within an aisle at a first location; and
displaying a smaller version of the image on a second display positioned within the aisle at a second location, the first location being nearer an end of the aisle than the second location.

9. The method of claim 8, wherein the first and second displays are mounted to a shelf of the aisle.

10. The method of claim 8, wherein the first location is proximate the end of the aisle.

11. The method of claim 8, further comprising:
displaying a second smaller version of the image on a third display positioned within the aisle at a third location, the second smaller version being smaller than the smaller version and the third location being further from the end of the aisle than the second location.

12. The method of claim 8, wherein the first and second displays extend out from a shelf of the aisle.

13. The method of claim 8, wherein the first and second displays are positioned above the aisle.

14. The method of claim 8, wherein the displays are positioned perpendicular to one or more shelves of the aisle.

15. One or more computer storage media storing computer executable instructions which when executed by one or more processors perform a method for generating a forced perspective, the method comprising:
displaying an image on a first display positioned within an aisle at a first location; and
displaying a smaller version of the image on a second display positioned within the aisle at a second location, the first location being nearer an end of the aisle than the second location.

16. The computer storage media of claim 15, wherein the first and second displays are mounted to a shelf of the aisle.

17. The computer storage media of claim 15, wherein the first location is proximate the end of the aisle.

18. The computer storage media of claim 15, further comprising:
displaying a second smaller version of the image on a third display positioned within the aisle at a third location, the second smaller version being smaller than the smaller version and the third location being further from the end of the aisle than the second location.

19. The computer storage media of claim 15, wherein the first and second displays extend out from a shelf of the aisle.

20. The computer storage media of claim 15, wherein the first and second displays are positioned above the aisle.
